(19) United States
(12) Patent Application Publication
(10) Pub. No.: US 2020/0041299 A1
(43) Pub. Date: Feb. 6, 2020

(54) PASSING GATE DETERMINING DEVICE, VEHICLE CONTROL SYSTEM, PASSING GATE DETERMINING METHOD, AND PROGRAM

(71) Applicant: HONDA MOTOR CO., LTD., Minato-ku, Tokyo (JP)

(72) Inventors: Daichi Kato, Wako-shi (JP); Akihiko Otsu, Wako-shi (JP); Akira Mizutani, Wako-shi (JP); Atsushi Ishioka, Wako-shi (JP); Kazuyuki Takahashi, Wako-shi (JP)

(21) Appl. No.: 16/481,927

(22) PCT Filed: Feb. 3, 2017
(86) PCT No.: PCT/JP2017/003971

§ 371 Date: Jul. 30, 2019

(51) Int. Cl. G01C 21/34; G08G 1/01; G05D 1/00; G06Q 50/30

(52) U.S. Cl. CPC G01C 21/3492; G08G 1/0125; G06Q 2240/00; G06Q 50/30; G05D 2201/0213; G05D 1/0088

(57) ABSTRACT

A passing gate determining device includes: an information acquirer configured to acquire information; and a gate selector configured to select a gate near a destination set in advance with priority at a tollgate in which a plurality of gates are disposed in parallel with each other on the basis of the information acquired by the information acquirer.

### TECHNICAL FIELD

The present invention relates to a passing gate determining device, a vehicle control system, a passing gate determining method, and a storage medium.

### BACKGROUND ART

Conventionally, an invention of a navigation device that recognizes operating gates at a tollgate by processing a captured image, identifies any one of the recognized operating gates, sets a travelling path from the current position of a vehicle to the identified operating gate, and displays the set travelling path on an HUD is disclosed (see Patent Literature 1).

### CITATION LIST

### Patent Literature

### Patent Literature 1

Japanese Unexamined Patent Application, First Publication No. 2014-119372

### SUMMARY OF INVENTION

### Technical Problem

In the conventional technology described above, travelling of a vehicle after passing through a tollgate is not considered. For this reason, a situation in which the vehicle needs to run with a course greatly changed after passing through a tollgate may occur.

The present invention is in consideration of such situations, and one object thereof is to provide a passing gate determining device, a vehicle control system, a passing gate determining method, and a storage medium program enabling a vehicle to run more smoothly after passing through a tollgate.

### Solution to Problem

(1): A passing gate determining device including: an information acquirer configured to acquire information; and a gate selector configured to select a gate near a destination set in advance with priority at a tollgate in which a plurality of gates are disposed in parallel with each other on the basis of the information acquired by the information acquirer.

(2): The passing gate determining device according to (1) described above, wherein the information acquirer acquires at least one piece of information of a structure of the tollgate, a state of each gate of the tollgate, and a lane in which the vehicle is travelling, and the gate selector selects a gate on the basis of the information acquired by the information acquirer.

(3): The passing gate determining device according to (1) described above, wherein the information acquirer acquires at least information of a lane in which the vehicle is travelling, and the gate selector selects a gate from among a gate group having a first gate having a highest degree of appropriateness to the destination set in advance and a second gate positioned at a destination acquired by directly extending the lane in which the vehicle is travelling as both ends.

(4): The passing gate determining device according to (3) described above, wherein the information acquirer acquires information of other vehicles directed toward the tollgate, and the gate selector selects a gate positioned on a second gate side in a case in which a degree of congestion in front of the tollgate, which is acquired using the information acquired by the information acquirer, is high and selects a gate positioned on a first gate side in a case in which the degree of congestion in front of the tollgate is low.

(5): The passing gate determining device according to (1) described above, wherein the information acquirer acquires a position of the vehicle, and the gate selector selects a gate positioned on a straight line joining a beginning-end portion of a branching road directed toward the destination set in advance and a current position of the vehicle.

(6): The passing gate determining device according to (1) described above, wherein the information acquirer acquires a position of a nearby vehicle in the vicinity of the vehicle, and the gate selector selects a gate on the basis of the position of the nearby vehicle acquired by the information acquirer.

(7): The passing gate determining device according to (1) described above further including a mounting state detector configured to detect whether or not a medium used for an automatic toll collecting system is mounted in a medium mounting unit, wherein the gate selector selects a gate on the basis of a detection result acquired by the mounting state detector.

(8): The passing gate determining device according to (7) described above, wherein the information acquirer acquires positions of other vehicles in the vicinity of the vehicle, and the gate selector, in a case in which it is determined by the mounting state detector that the medium is mounted in the medium mounting unit, selects a gate corresponding to the automatic toll collecting system with priority, and in a case in which it is recognized that there are many vehicles directed toward the gate corresponding to the automatic toll collecting system on the basis of the positions of the other vehicles acquired by the information acquirer, selects a gate at which the number of other vehicles is small regardless of whether or not the gate is the gate corresponding to the automatic toll collecting system.

(9): The passing gate determining device according to (7) described above, wherein the gate selector, when a user sets the destination, determines whether a gate corresponding to the automatic toll collecting system is selected or a gate not corresponding to the automatic toll collecting system is selected on the basis of a set preferred item set.

(10): The passing gate determining device according to (7) described above, wherein the gate selector selects a gate corresponding to the automatic toll collecting system with priority in a case in which it is detected by the mounting state detector that the medium is mounted in the medium mounting unit and sets a gate not corresponding to the automatic toll collecting system as a selection target even in a case in which it is detected by the mounting state detector that the medium is mounted in the medium mounting unit in a case in which there is no application of a discount according to use of the automatic toll collecting system.

(11): The passing gate determining device according to (1) described above, wherein the gate selector repeatedly selects a gate on the basis of the information acquired by the information acquirer and selects a gate such that a gate that has been selected is selected with priority in second and subsequent selections.

(12): The passing gate determining device according to (1) described above, wherein the gate selector selects a gate on the basis of a position of a left side or a right side on which a driver seat is present in the vehicle.

(13): The passing gate determining device according to (1) described above further includes an output unit configured to output information, wherein the gate selector outputs information of the selected gate to the output unit as a candidate for a gate to pass.

(14): A vehicle control system including: a passing gate determining device according to (1) described above; and an automated driving controller configured to execute automated driving such that the vehicle passes through the gate selected by the passing gate determining device.

(15) The vehicle control system according to (14) described above, the automated driving controller executes automated driving such that the vehicle runs in a lane near the gate selected by the gate selector of the passing gate determining device when it comes within a predetermined distance from the tollgate.

(16): A passing gate determining method using a computer, the passing gate determining method including: acquiring information; and selecting a gate near a destination set in advance with priority at a tollgate in which a plurality of gates are disposed in parallel with each other on the basis of the acquired information.

(17): A computer-readable non-transitory storage medium storing a program causing a computer to execute: acquiring information; and selecting a gate near a destination set in advance with priority at a tollgate in which a plurality of gates are disposed in parallel with each other on the basis of the acquired information.

### Advantageous Effects of Invention

According to (1) to (6) and (11) to (17) described above, a vehicle can be caused to run more smoothly after passing through a tollgate.

According to (7) to (10) described above, furthermore, a gate can be selected more appropriately on the basis of whether the automatic toll collecting system is supported.

### BRIEF DESCRIPTION OF DRAWINGS

FIG. 1 is a diagram illustrating one example of the configuration of a vehicle system 1.

FIG. 2 is a diagram illustrating a view in which a relative position and a relative posture of a vehicle M with respect to a travelling lane L1 are recognized by a subject vehicle position recognizer.

FIG. 3 is a diagram illustrating a view in which a target trajectory is generated on the basis of a recommended lane.

FIG. 4 is a functional configuration diagram of a tollgate passage controller.

FIG. 5 is a flowchart illustrating an overview of the flow of a process executed by the tollgate passage controller.

FIG. 6 is an image diagram illustrating a view in which a gate is selected using a technique 1.

FIG. 7 is a flowchart illustrating one example of the flow of a process executed by a gate selector in accordance with the technique 1.

FIG. 8 is a diagram illustrating one example of a process of extracting gate candidates GC in accordance with the technique 1.

FIG. 9 is a diagram illustrating each score according to a technique 2.

FIG. 10 is a diagram illustrating a view in which an integral score SC total is acquired for each gate.

FIG. 11 is a diagram illustrating a target trajectory that may be generated in a case in which a technique 3 is used.

FIG. 12 is an image diagram illustrating a view in which a gate is selected using a technique 4.

FIG. 13 is an image diagram illustrating a view in which a gate selector according a second embodiment selects a gate;

FIG. 14 is a diagram illustrating one example of a destination setting screen IM1.

FIG. 15 is a flowchart illustrating the flow of a process executed by a gate selector according to the second embodiment.

FIG. 16 is a flowchart illustrating an overview of the flow of a process executed by a tollgate passage controller according to modified example 1.

FIG. 17 is an image diagram illustrating a view in which a gate selector according to modified example 2 selects a gate.

FIG. 18 is a diagram illustrating one example of a selected gate notification screen IM2.

### DESCRIPTION OF EMBODIMENTS

Hereinafter, a passing gate determining device, a vehicle control system, a passing gate determining method, and a program according to embodiments of the present invention will be described with reference to the drawings. A passing gate determining device may be a part of a device determining a path in which a vehicle is to run and guiding a vehicle performing manual driving along the path (a so-called navigation device) and may be a device that assists with the process of determining a target trajectory that is a guideline for automated driving in a vehicle performing automated driving.

### <First Embodiment>

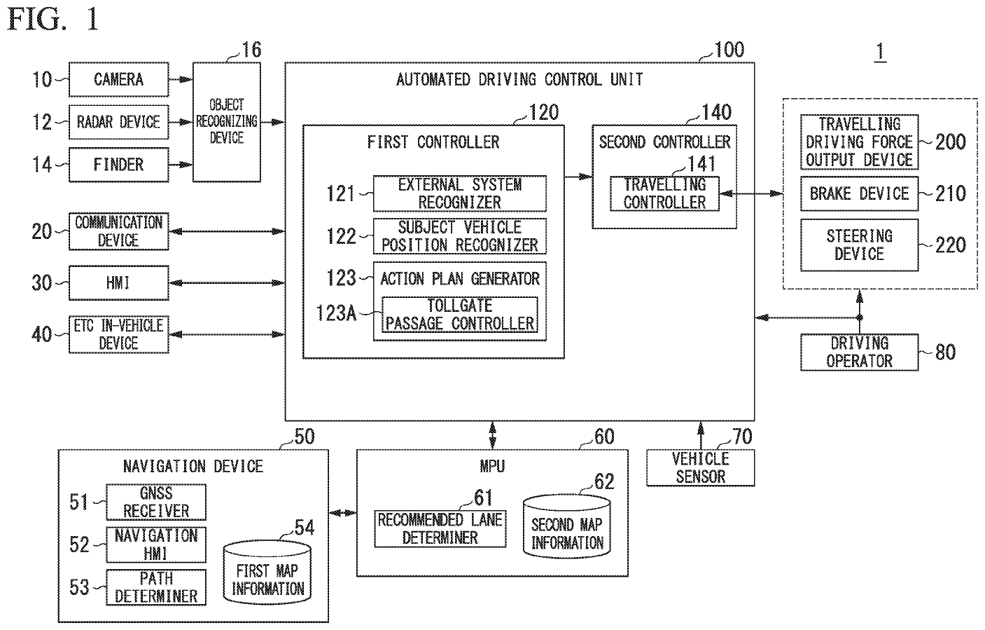

FIG. 1 is a diagram illustrating one example of the configuration of a vehicle system 1 according to a first embodiment. In the vehicle system 1, for example, a camera 10, a radar device 12, a finder 14, an object recognizing device 16, a communication device 20, a human machine interface (HMI) 30, an ETC in-vehicle device 40, a navigation device 50, a micro-processing unit (MPU) 60, a vehicle sensor 70, a driving operator 80, an automated driving control unit 100, a travelling driving force output device 200, a brake device 210, and a steering device 220 are mounted. Such devices and units are interconnected using a multiplex communication line such as a controller area network (CAN) communication line, a serial communication line, a radio communication network, or the like. In addition, the configuration illustrated in FIG. 1 is merely one example, and thus some components may be omitted and other components may be added.

The camera 10, for example, is a digital camera using a solid-state imaging device such as a charge coupled device (CCD) or a complementary metal oxide semiconductor (CMOS). One or a plurality of cameras 10 are installed at arbitrary places of the vehicle M. In a case in which the side in front is to be imaged, the camera 10 is installed at an upper part of a front windshield, a rear face of a rear-view mirror, or the like. The camera 10, for example, repeatedly images the vicinity of the vehicle M periodically. The camera 10 may be a stereo camera.

The radar device 12 emits radio waves such as millimeter waves to the vicinity of the vehicle M and detects at least a position (a distance and an azimuth) of an object by detecting radio waves (reflected waves) reflected by the object. One or a plurality of radar devices 12 are installed at arbitrary places in the vehicle M. The radar device 12 may detect a position and a speed of an object using a frequency modulated continuous wave (FM-CW) system.

The finder 14 is a light detection and ranging or a laser imaging detection and ranging (LIDAR) finder that detects a distance to a target by measuring light scattered from emitted light. One or a plurality of finders 14 are installed at arbitrary places in the vehicle M.

The object recognizing device 16 may perform a sensor fusion process on results of detection using some or all of the camera 10, the radar device 12, and the finder 14, thereby recognizing a position, a type, a speed, and the like of an object. The object recognizing device 16 outputs a result of recognition to the automated driving control unit 100. In addition, the object recognizing device 16 may output a part of information input from the camera 10, the radar device 12, or the finder 14 to the automated driving control unit 100 as it is.

The communication device 20, for example, communicates with other vehicles in the vicinity of the vehicle M or a road-side device using a cellular network, a Wi-Fi network, Bluetooth (registered trademark), dedicated short range communication (DSRC), or the like or communicates with various server apparatuses through a radio base station.

The HMI 30 presents various types of information to a vehicle occupant of the vehicle M and accepts an input operation performed by the vehicle occupant. The HMI 30 includes various display devices, a speaker, a buzzer, a touch panel, a switch, a key, a vibrator attached to a sheet or a steering wheel, and the like.

The ETC in-vehicle device 40 is a device for using an automatic toll collecting system. The ETC in-vehicle device 40 includes a mounting unit in which an ETC card is mounted and a radio communication unit that communicates with an ETC road-side device disposed at a gate of a toll road. The radio communication unit may be configured to be common to the communication device 20. The ETC in-vehicle device 40 exchanges information of an entrance tollgate, an exit tollgate, and the like by communicating with the ETC road-side device. The ETC road-side device determines a charging amount for the vehicle occupant of the subject vehicle M on the basis of such information and proceeds with a billing process.

The navigation device 50, for example, includes a global navigation satellite system (GNSS) receiver 51, a navigation HMI 52, and a path determiner 53 and stores first map information 54 in a storage device such as a hard disk drive (HDD) or a flash memory. The GNSS receiver identifies a position of the vehicle M on the basis of signals received from GNSS satellites. The position of the vehicle M may be identified or supplemented by an inertial navigation system (INS) using an output of the vehicle sensor 70. The navigation HMI 52 includes a display device, a speaker, a touch panel, a key, and the like. A part or the whole of the navigation HMI 52 and the HMI 30 described above may be configured to be shared. The path determiner 53, for example, determines a path from a location of the vehicle M identified by the GNSS receiver 51 (or an input arbitrary location) to a destination input by the vehicle occupant using the navigation HMI 52 by referring to the first map information 54. The first map information 54, for example, is information in which a road form is represented by respective links representing a road and respective nodes connected using the links. The first map information 54 may include a curvature of each road, point of interest (POI) information, and the like. The path determined by the path determiner 53 is output to the MPU 60. In addition, the navigation device 50 may perform path guidance using the navigation HMI 52 on the basis of the path determined by the path determiner 53. Furthermore, the navigation device 50, for example, may be realized by a function of a terminal device such as a smartphone or a tablet terminal carried by a user. In addition, the navigation device 50 may transmit a current location and a destination to a navigation server through the communication device 20 and acquire a path received from the navigation server as a reply.

The MPU 60, for example, functions as a recommended lane determiner 61 and stores second map information 62 in a storage device such as an HDD or a flash memory. The recommended lane determiner 61 divides a path provided from the navigation device 50 into a plurality of blocks (for example, divides the path into blocks of 100 m in the advancement direction of the vehicle) and determines a recommended lane for each block by referring to the second map information 62. The recommended lane determiner 61 determines which lane to run from the left side. In a case in which a branching place, a merging place, or the like is present in the path, the recommended lane determiner 61 determines a recommended lane such that the vehicle M can run on a reasonable travelling path for advancement to divergent destinations.

The second map information 62 is map information having an accuracy higher than that of the first map information 54. The second map information 62, for example, includes information of the center of respective lanes, information on boundaries between lanes, or the like. In addition, in the second map information 62, road information, traffic regulations information, address information (address and zip code), facilities information, telephone number information, and the like may be included. In the road information, information representing a type of road such as an expressway, a toll road, a national highway, or a prefectural road, the number of lanes of a road, a width of each lane, a gradient of a road, a position of a road (three-dimensional coordinates including longitude, latitude, and a height), a curvature of the curve of a lane, locations of merging and branching points of lanes, a sign installed on a road, a gate structure for each tollgate (information of the number of gates, gates that are dedicated for ETC, and the like), and the like are included. The second map information 62 may be updated as is necessary by accessing another device using the communication device 20.

The vehicle sensor 70 includes a vehicle speed sensor detecting a speed of the vehicle M, an acceleration sensor detecting an acceleration, a yaw rate sensor detecting an angular velocity around a vertical axis, an azimuth sensor detecting the direction of the vehicle M, and the like.

The driving operator 80, for example, includes an acceleration pedal, a brake pedal, a shift lever, a steering wheel, and other operators. A sensor detecting the amount of an operation or the presence/absence of an operation is installed in the driving operator 80, and a result of detection acquired by the sensor described above is output to the automated driving control unit 100 or the travelling driving force output device 200 and one or both of the brake device 210 and the steering device 220.

The automated driving control unit 100, for example, includes a first controller 120, a second controller 140, and a vehicle occupant state detector 160. Each of the first controller 120, the second controller 140, and the vehicle occupant state detector 160 is realized by a processor such as a central processing unit (CPU) executing a program (software). In addition, some or all of the functional units of the first controller 120, the second controller 140, and the vehicle occupant state detector 160 to be described below may be realized by hardware such as a large scale integration (LSI), an application specific integrated circuit (ASIC), a field-programmable gate array (FPGA), or the like or may be realized by software and hardware in cooperation. The first controller 120, for example, includes the external system recognizer 121, the subject vehicle position recognizer 122, and the action plan generator 123.

The external system recognizer 121 recognizes states of nearby vehicles such as positions, speeds, and accelerations on the basis of information input from the camera 10, the radar device 12, and the finder 14 directly or through the object recognizing device 16. The position of a nearby vehicle may be represented as a representative point of the nearby vehicle such as the center of gravity, a corner, or the like and may be represented by an area represented by the contour of the nearby vehicle. The “state” of a nearby vehicle may include an acceleration or a jerk or may be an “action state” (for example, the vehicle is changing lanes or is to change lanes) of the nearby vehicle. In addition, the external system recognizer 121 may recognize positions of guard rails, electric poles, parked vehicles, pedestrians, and other objects in addition to nearby vehicles.

The subject vehicle position recognizer 122, for example, recognizes a lane (travelling lane) in which the vehicle M runs and a relative position and a posture of the vehicle M with respect to the travelling lane. The subject vehicle position recognizer 122, for example, by comparing a pattern (for example, an array of solid lines and broken lines) of a road partition line that is acquired from the second map information 62 with a pattern of the road partition line in the vicinity of the vehicle M that is recognized from an image captured by the camera 10, recognizes a travelling lane. In the recognition, the position of the vehicle M acquired from the navigation device 50 and a processing result acquired using the INS may be additionally taken into account.

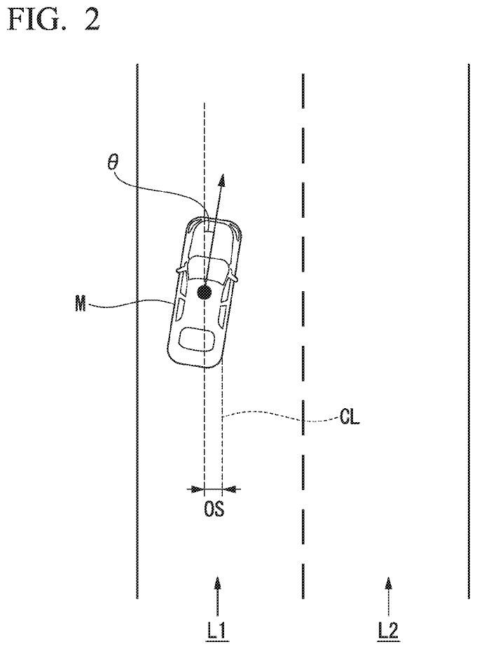

Then, the subject vehicle position recognizer 122, for example, recognizes a position and a posture of the vehicle M with respect to the travelling lane. FIG. 2 is a diagram illustrating a view in which a relative position and a posture of a vehicle M with respect to a travelling lane L1 are recognized by the subject vehicle position recognizer 122. The subject vehicle position recognizer 122, for example, recognizes an offset OS of a reference point (for example, center of gravity) of the vehicle M from travelling lane center CL and an angle θ of an advancement direction of the vehicle M formed with respect to a line acquired by aligning the travelling lane center CL as a relative position and a posture of the vehicle M with respect to the travelling lane L1. In addition, instead of this, the subject vehicle position recognizer 122 may recognize a position of the reference point of the vehicle M with respect to one side end of the travelling lane L1 or the like as a relative position of the vehicle M with respect to the travelling lane. The relative position of the vehicle M recognized by the subject vehicle position recognizer 122 is provided for the recommended lane determiner 61 and the action plan generator 123.

The action plan generator 123 determines events to be sequentially executed in automated driving such that the vehicle M runs in a recommended lane determined by the recommended lane determiner 61 and deals with a surrounding status of the vehicle M. As the events, for example, there are a constant-speed travelling event in which the subject vehicle runs at a constant speed in the same travelling lane, a following travelling event in which the subject vehicle follows a vehicle travelling ahead, a lane changing event, a merging event, a branching event, an emergency stop event, a tollgate event for passing through a tollgate, a handover event for ending automated driving and switching to manual driving, and the like. In addition, during the execution of such an event, there are cases in which an action for avoidance is planned on the basis of surrounding statuses of the vehicle M (the presence/absence of nearby vehicles and pedestrians, lane contraction according to road construction, and the like).

The action plan generator 123 generates a target trajectory in which the vehicle M will run in the future. The target trajectory, for example, includes a speed element.

For example, the target trajectory is generated as a set of target points (trajectory points) to be reached at reference times by setting a plurality of the reference times in the future for every predetermined sampling time (for example, a fraction of a [sec]). For this reason, in a case in which an interval between trajectory points is large, it represents that the vehicle runs in a section between the trajectory points at a high speed.

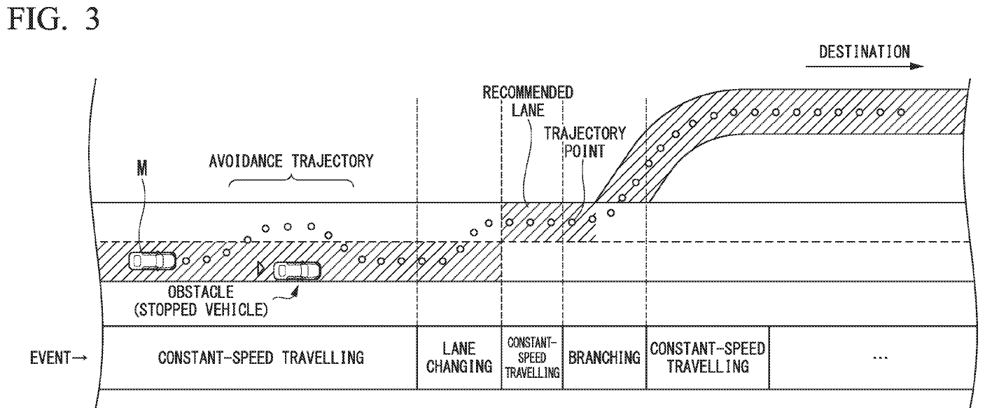

FIG. 3 is a diagram illustrating a view in which a target trajectory is generated on the basis of a recommended lane. As illustrated in the drawing, the recommended lane is set such that it is convenient for the subject vehicle to run along a path to a destination. When the subject vehicle reaches a point before a predetermined distance from a recommended lane switching place (may be determined in accordance with a type of event), the action plan generator 123 starts the lane changing event, the branching event, the merging event, or the like. In a case in which there is a need for avoiding an obstacle during the execution of each event, as illustrated in the drawing, an avoidance trajectory is generated.

The action plan generator 123, for example, generates a plurality of candidates of a target trajectory and selects a target trajectory that is optimal at that time point on the basis of the viewpoints of safety and efficiency.

The action plan generator 123 includes a tollgate passage controller 123A as a sub functional unit for executing a tollgate event. This will be described later.

The second controller 140 includes a travelling controller 141. The travelling controller 141 controls the travelling driving force output device 200, the brake device 210, and the steering device 220 such that the subject vehicle M passes along a target trajectory generated by the action plan generator 123 at a scheduled time.

The travelling driving force output device 200 outputs a travelling driving force (torque) for allowing a vehicle to run to driving wheels. The travelling driving force output device 200, for example, includes a combination of an internal combustion engine, an electric motor, a transmission gear, and the like and an ECU controlling such components. The ECU controls the components described above on the basis of information input from the automated driving control unit 100 or information input from the driving operator 80.

The brake device 210, for example, includes a brake caliper, a cylinder delivering hydraulic pressure to the brake caliper, an electric motor generating hydraulic pressure in the cylinder, and a brake ECU. The brake ECU controls the electric motor on the basis of the information input from the automated driving control unit 100 or the information input from the driving operator 80 such that a brake torque corresponding to a braking operation is output to each vehicle wheel. The brake device 210 may include a mechanism that delivers a hydraulic pressure generated in accordance with an operation for a brake pedal included in the driving operator 80 to the cylinder through a master cylinder as a backup. In addition, the brake device 210 is not limited to the configuration described above and may be an electronic control-type hydraulic brake device that delivers a hydraulic pressure of the master cylinder to the cylinder by controlling an actuator on the basis of information input from the travelling controller 141.

The steering device 220, for example, includes a steering ECU and an electric motor. The electric motor, for example, changes the direction of the steering wheel by applying a force to a rack and pinion mechanism. The steering ECU changes the direction of the steering wheel by driving the electric motor in accordance with information input from the automated driving control unit 100 or information input from the driving operator 80.

### [Tollgate Passage Control]

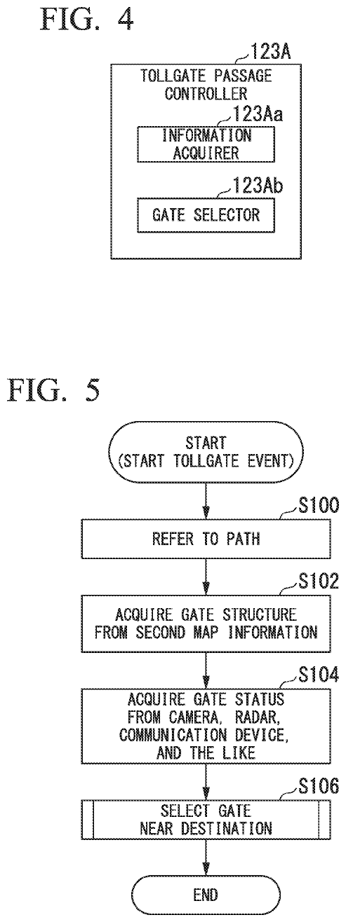

Hereinafter, the function of the tollgate passage controller 123A will be described. FIG. 4 is a functional configuration diagram of the tollgate passage controller 123A. The tollgate passage controller 123A, for example, includes an information acquirer 123Aa and a gate selector 123Ab.

FIG. 5 is a flowchart illustrating an overview of the flow of a process executed by the tollgate passage controller 123A. The process of this flowchart, for example, starts as a process relating to a tollgate event when it becomes a predetermined distance (for example, about several [km]) to a tollgate.

First, the information acquirer 123Aa of the tollgate passage controller 123A acquires a gate structure of a tollgate present in front of the subject vehicle M from the second map information (Step S102) by referring to a path generated by the navigation device 50 (Step S100) and acquires a gate status from the camera 10, the radar device 12, the communication device 20, and the like (Step S104).

The gate status, for example, is information indicating which gate is an invalid gate (closed gate), the number of vehicles aligned in front of a gate, and the like. The information acquirer 123Aa acquires such information by analyzing an image acquired by the camera 10, extracting a vehicle from a detection result acquired by the radar device 12, and communicating with other vehicles and a communication device on the tollgate side using the communication device 20.

Then, the gate selector 123Ab selects a gate close to a destination on the basis of information acquired by the information acquirer 123Aa (Step S106).

Here, details of a gate selecting process according to a first embodiment will be described. The gate selector 123Ab according to the first embodiment, for example, selects a gate using any one or a combination of techniques illustrated below as examples.

### (Technique 1)

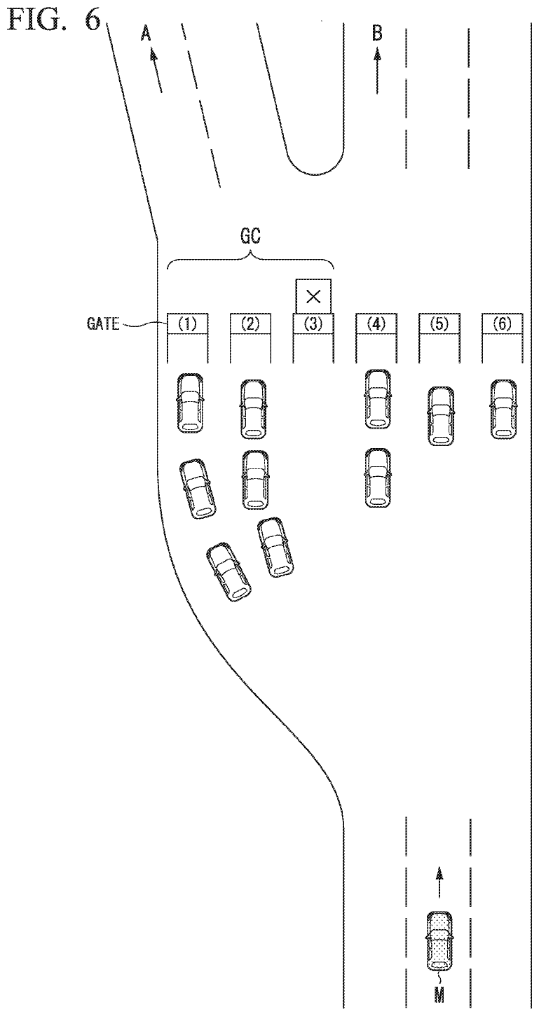

The gate selector 123Ab, for example, selects one or more gates close to a destination set in advance as gate candidates and selects (finalizes) one gate among them on the basis of gate statuses. FIG. 6 is an image diagram illustrating a view in which a gate is selected using a technique 1. In the drawing, since a destination set in a subject vehicle M is a field A, it is assumed that a path directed in the field A is set by the navigation device 50. In this case, first, gates (1) to (3) close to the field A are selected as gate candidates GC. Among these, it is assumed that the gate (3) is perceived as an invalid gate from gate statuses. Accordingly, the gate selector 123Ab selects an appropriate gate out of the gates (1) and (2).

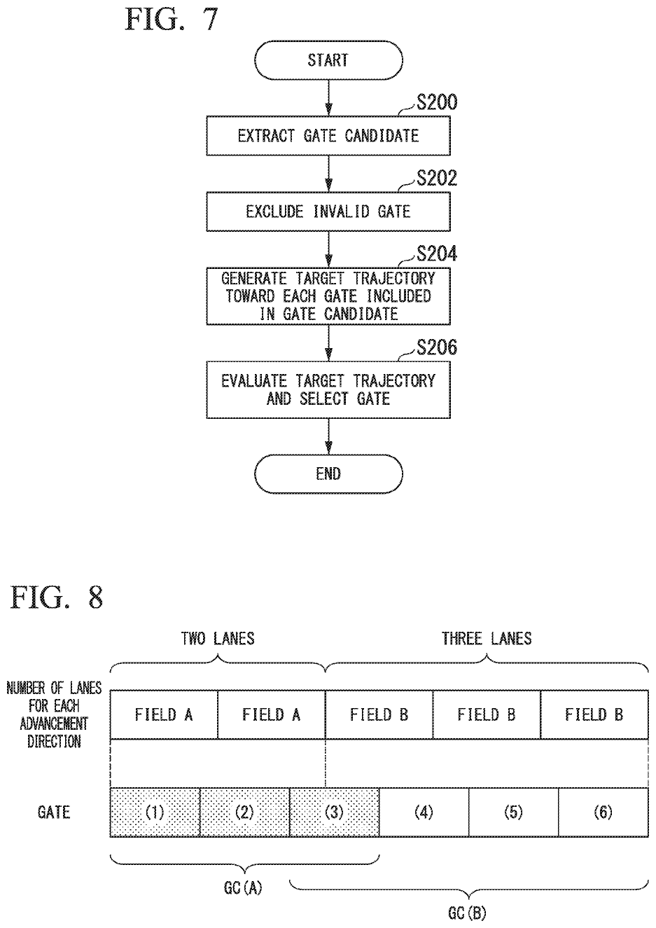

FIG. 7 is a flowchart illustrating one example of the flow of a process executed by the gate selector 123Ab in accordance with the technique 1. First, the gate selector 123Ab extracts gate candidates GC (Step S200).

FIG. 8 is a diagram illustrating one example of a process of extracting gate candidates GC in accordance with the technique 1. The gate selector 123Ab, for example, acquires the number of lanes of each of advancement directions (the field A and the field B) and extracts gate candidates GC by proportionally dividing the gates at the ratio (2:3) of the numbers of lanes for the fields in order from the end. In other words, as a principle, gates up to 2/5 from the left end are set as gate candidates GC(A) for advancement to the field A, and gates up to 3/5 from the right end are set as gate candidates GC(B) for advancement to the field B. Here, the gate (3) corresponding to a boundary line at the time of proportional division is included in both the gate candidates GC(A) and GC(B). According to this technique, in the example illustrated in FIG. 6, the gates (1) to (3) are extracted as gate candidates GC. In addition, instead of proportional division of only the numbers of lanes, gate candidates GC may be extracted with extending angles of the advancement directions with respect to a reference direction taken into account. The reference direction may be a direction perpendicular to a direction in which gates are aligned or may be an extending direction of an ordinary road before width extension before a tollgate. For example, in a case in which a branching road toward the field A is directed to the left side at an acute angle with respect to the reference direction, gate candidates GC may be narrowed down for leaning to a further left side (for example, only the gates (1) and (2) are extracted as gate candidates GC).

The description will be returned with reference to FIG. 7. Next, the gate selector 123Ab excludes invalid gates (Step S202). Then, the gate selector 123Ab generates a target trajectory to each gate included in the gate candidates GC using the function of the action plan generator 123 described above (Step S204) and selects one target trajectory by evaluating the target trajectories, thereby selecting a gate through which the subject vehicle M passes (Step S206).

The evaluation of a target trajectory is performed using various criteria. For example, in addition to a criterion relating to acceleration/deceleration and a steering angle for every predetermined time, the number of other vehicles aligning before each gate and a length of a target trajectory, a virtual number of times of lane change until aligning in a vehicle row, or the like may be used as the criterion.

In accordance with such control, a gate close to a destination set in advance is selected. As a result, after passing through a tollgate (gate), the subject vehicle M can smoothly advance in the direction of the destination.

### (Technique 2)

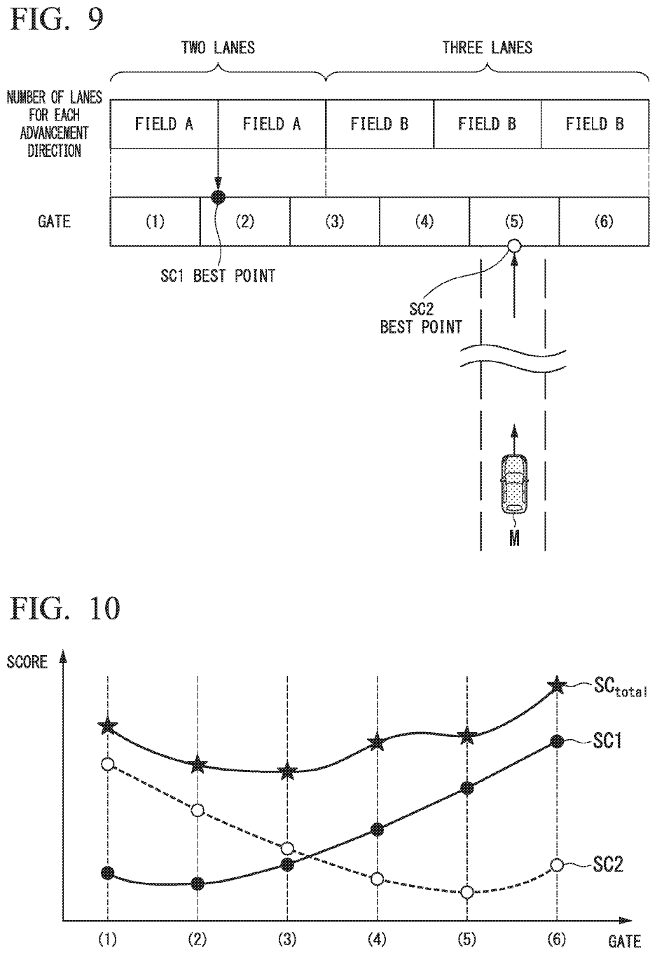

The gate selector 123Ab may assign a first score SC1 on the basis of appropriateness for the direction of a destination to a gate, assign a second score SC2 on the basis of the horizontal position of the subject vehicle M to the gate, and select a gate by integrating both the scores. FIG. 9 is a diagram illustrating each score according to a technique 2.

The first score SC1 is determined on the basis of a way similar to that of the technique 1 described with reference to FIG. 8. In the technique 1, in a case in which a vehicle is directed toward a field A, “gates from the left end to 2/5” are set as gate candidates GC(A) for advancement to the field A. In the technique 2, a higher first score SC1 is assigned as “a gate is closer to the center of a gate group from the left end to 2/5 (in other words, a gate closer to the position of 1/5 from the left side)”. In the example illustrated in FIG. 9, a position of a gate (2) on a gate (1) side is a point at which the first score SC1 is the highest, and the gate (2) corresponding to the point is a gate that has a highest degree of appropriateness for the direction of a destination.

The second score SC2, for example, has a high value as a gate is a gate that is reached in a case in which a lane, in which the subject vehicle M is travelling, is directed extended and the subject vehicle runs within the extended lane. In the example illustrated in FIG. 9, a center point of a gate (5) is a point at which the second score SC2 is the highest. In addition, for both the first score SC1 and the second score SC2, as the values become smaller, it represents a better gate.

Then, the gate selector 123Ab acquires an integral score SCₜₒₜₐₗ for each gate, for example, by adding the first score and the second score. FIG. 10 is a diagram illustrating a view in which an integral score SCₜₒₜₐₗ is acquired for each gate. In the example illustrated in FIG. 10, since the integral score SCₜₒₜₐₗ of the gate (3) is the lowest (best), the gate (3) is selected as a gate through which the subject vehicle M will pass. In addition, in a case in which the gate (3) is an invalid gate, a gate (2) of which the integral score SCₜₒₜₐₗ is the lowest after that is selected.

In addition, also in the technique 2, similar to the technique 1, a target trajectory may be generated for each of gates of which the integral scores SCₜₒₜₐₗ are highly ranked, and a gate may be selected by evaluating the target trajectory.

In accordance with such control, a gate which is located near a destination set in advance and to which the subject vehicle M can easily advance from the position of the subject vehicle M is selected. As a result, the subject vehicle M can easily approach a tollgate (gate) and can smoothly advance in the direction of a destination after passing through the tollgate.

### (Technique 3)

The gate selector 123Ab may select a gate among a gate group having a gate having a highest degree of appropriateness for the direction of a destination (see the technique 2) and a gate that is reached in a case in which a lane in which the subject vehicle M is travelling is directly extended, and the subject vehicle runs within the lane as its both ends. When the example illustrated in FIG. 9 is cited, the gate selector 123Ab selects a gate through which the subject vehicle M will pass among gates (2) to (5) having the gate (2) having a highest degree of appropriateness for the direction of a destination and the gate (5) that is reached in a case in which the subject vehicle M runs within the lane as its both ends.

In this case, the gate selector 123Ab, for example, may select a gate near the right side for which remaining lane change is not necessary when the degree of congestion in front of the tollgate is high and select a gate near the left side through which advancement to the destination side can be smoothly performed after passing through the tollgate when the degree of congestion in front of the tollgate is low. The reason for this is that, usually, the traffic is not congested much after passing through a tollgate even when the degree of congestion in front of the tollgate is high. The degree of congestion in front of a tollgate, for example, is calculated on the basis of the number of other vehicles directed toward the tollgate with respect to the area in front of the tollgate.

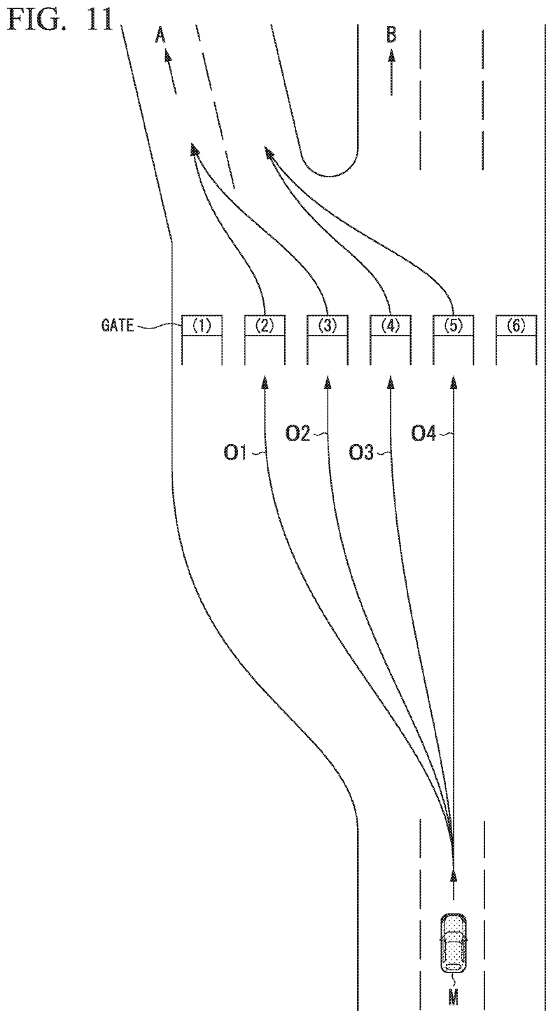

FIG. 11 is a diagram illustrating a target trajectory that may be generated in a case in which a technique 3 is used. The gate selector 123Ab generates a target trajectory O1 in a case in which the degree of congestion in front of the tollgate is the lowest level, generates a target trajectory O2 in a case in which the degree of congestion in front of the tollgate is a slightly low level, generates a target trajectory O3 in a case in which the degree of congestion in front of the tollgate is a slightly high level, and generates a target trajectory O4 in a case in which the degree of congestion in front of the tollgate is the highest level.

In accordance with such control, a gate which is located near a destination set in advance and to which advancement from the position of the subject vehicle M can be easily performed is selected. As a result, the subject vehicle M can smoothly approach the tollgate (gate) and smoothly advance in the direction of the destination after passing through the tollgate.

### (Technique 4)

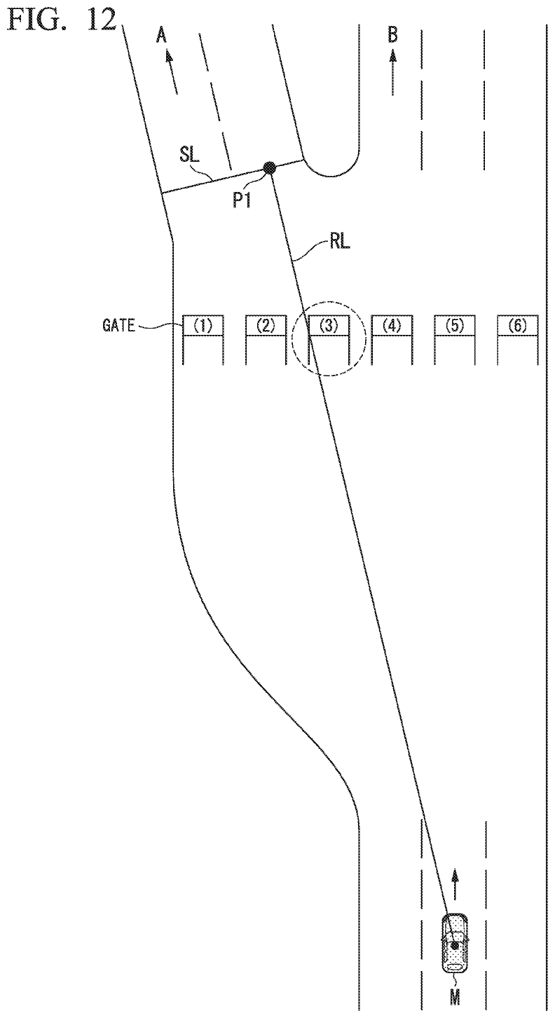

The gate selector 123Ab may select a gate on a straight line joining a beginning-end portion of a branching road directed toward a destination and the position of a subject vehicle M. FIG. 12 is an image diagram illustrating a view in which a gate is selected using a technique 4. In the drawing, P1 is a beginning-end portion for a branching road, RL is a straight line joining the beginning-end portion P1 and the position (precisely, the position of a representative point) of the subject vehicle M. In a case in which a branching road includes a plurality of lanes, for example, a beginning-end portion of the branching road is defined as a center portion of a lane on a side close to the subject vehicle M on a beginning-end line SL of the branching road on a map. In addition, in a case in which a branching road includes only one lane, a beginning-end portion of the branching road is defined as a center portion of the lane on a beginning-end line SL. Instead of this, a beginning-end portion of a branching road may be defined as a center portion of the entire branching road or the like. In the example illustrated in FIG. 12, the gate selector 123Ab selects a gate (3) through which the straight line RL passes as a gate through which the subject vehicle M passes.

In accordance with such control, a gate which is located near a destination set in advance and to which the subject vehicle M can easily run from the position of the subject vehicle M is selected. As a result, the subject vehicle M can easily approach a tollgate (gate) and can smoothly advance in the direction of a destination after passing through the tollgate.

According to the vehicle system 1 including the passing gate determining device according to the first embodiment described above, in a tollgate at which a plurality of gates are disposed in parallel with each other, by selecting a gate near a destination set in advance with priority, the vehicle can be caused to more smoothly run after passing through the tollgate.

### <Second Embodiment>

Hereinafter, a second embodiment will be described. A gate selector 123Ab according to the second embodiment selects a gate through which a subject vehicle M will pass on the basis of presence/absence of mounting of an ETC card detected by the ETC in-vehicle device 40. In addition, a gate selecting process according to the second embodiment can be combined with the gate selecting process according to the first embodiment. Hereinafter, the gate selecting process will be described to be performed using the technique 1 according to the first embodiment as a base.

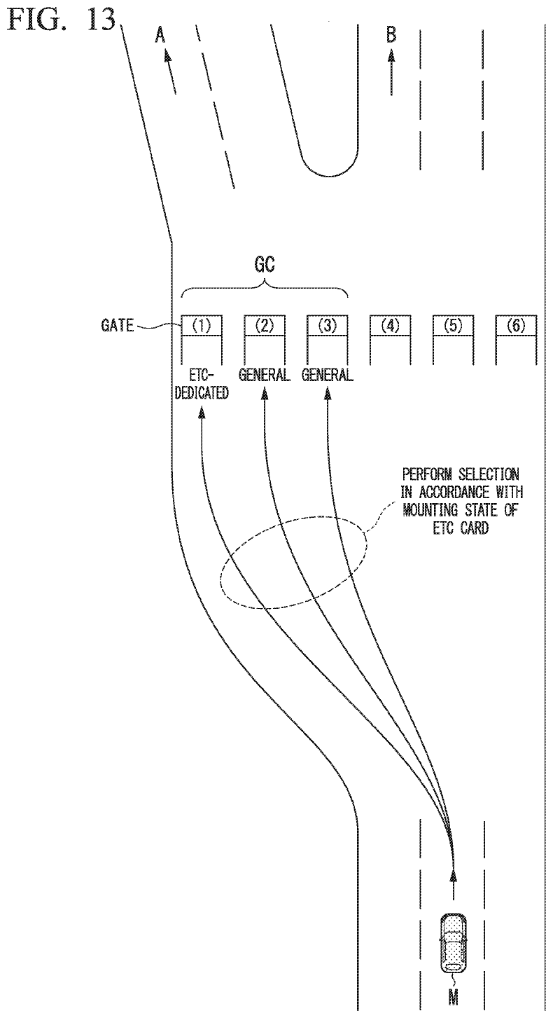

FIG. 13 is an image diagram illustrating a view in which a gate selector 123A according the second embodiment selects a gate. In the drawing, it is assumed that a destination set in the subject vehicle M is in a field A, and a path toward the field A is set by a navigation device 50. First, the gate selector 123A extracts gates (1) to (3) near in a direction A as gate candidates GC.

Among the gate candidates GC, the gate (1) is an ETC-dedicated gate, and the gates (2) and (3) are general gates. The ETC-dedicated gate is a gate through which only a vehicle, in which an ETC card is mounted in the ETC in-vehicle device 40 (hereinafter, referred to as an ETC vehicle), can pass. A general gate is a gate collecting toll using a ticket without using an ETC. In addition, a gate may include an ETC/general gate (a gate through which a vehicle can pass using a desired method out of an ETC and a ticket). In a case in which the subject vehicle M is an ETC vehicle, there is a possibility that a discount is applied in accordance with passage of an ETC-dedicated gate, and accordingly, it is preferable for the subject vehicle M to pass through the ETC-dedicated gate. However, in a case in which an ETC-dedicated gate is more congested than the other gates, there may be cases in which passage through another gate, through which the subject vehicle can quickly pass, is considered to be preferable. As one element, in a case in which a vehicle occupant of the subject vehicle M directs “time preference” when a destination setting and a path search are performed, it is assumed that quick passage needs to be prioritized over application of a discount.

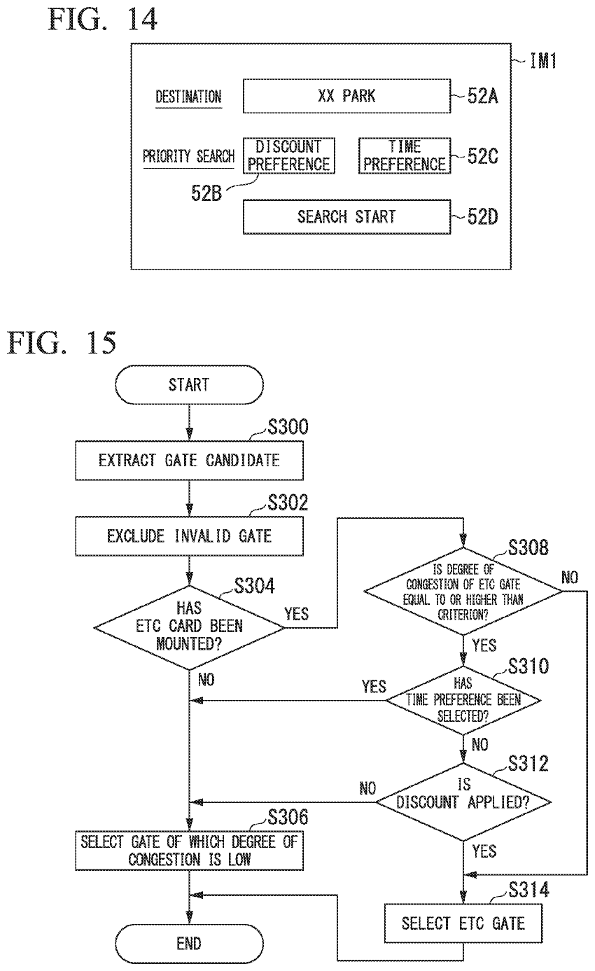

FIG. 14 is a diagram illustrating one example of a destination setting screen IM1. The destination setting screen IM1 is an interface screen provided by the navigation HMI 52 of the navigation device 50. Inputting of a destination is performed by inputting texts on an input window 52A, selecting a destination from a list on a screen different from the screen illustrated in the drawing, or inputting a destination using a voice of a vehicle occupant. In addition, on this screen, as a preference search mode, a discount preference button 52B used for directing “discount preference”, a time preference button 52C used for directing “time preference”, and a search start button 52D used for directing start of a path search are set. When a destination is input, and the search start button 52D is operated in a state in which the discount preference button 52B is selected, a path search prioritizing the application of a discount using an ETC or the like is is executed. On the other hand, when the search start button 52D is operated in a state in which the time preference button 52C is selected, a path search prioritizing shortening of a required time over the application of a discount is executed.

In addition, in a case in which application/non-application is changed depending on a day or a time period regarding the application of a discount, there may be cases in which a time period in which the subject vehicle M passes through the tollgate is a time period in which there is no application of a discount. Also in such cases, in a case in which an ETC-dedicated gate is more congested than the other gates, it is assumed that it is preferable to pass another gate through which the subject vehicle can quickly pass. In addition, the gate selector 123Ab acquires a schedule relating to the application of a discount by accessing a management server not illustrated in the drawing using the communication device 20 and can determine application/non-application of a discount on the basis thereof.

FIG. 15 is a flowchart illustrating the flow of a process executed by the gate selector 123Ab according to the second embodiment. First, the gate selector 123Ab, similar to the technique 1 according to the first embodiment, extracts gate candidates GC (Step S300) and excludes invalid gates (Step S302). Here, the gate selector 123Ab may include at least one of an ETC-dedicated gate and an ETC/general gate in the gate candidate GC.

Next, the gate selector 123Ab determines whether or not an ETC card is mounted in the ETC in-vehicle device 40 (Step S304). In a case in which no ETC card is mounted in the ETC in-vehicle device 40, the gate selector 123Ab selects a gate of which the degree of congestion is low among gate candidates GC (Step S306). In addition, the degree of congestion, for example, is represented by the number of vehicles directed toward a gate.

On the other hand, in a case in which an ETC card is mounted in the ETC in-vehicle device 40, the gate selector 123Ab determines whether or not the degree of congestion of an ETC gate (an ETC-dedicated gate or an ETC/general gate) among gates included in the gate candidates GC is equal to or higher than a criterion (for example, a predetermined numbers or more) (Step S308). In addition, in a case in which a plurality of ETC gates are present, it may be determined “whether or not the degrees of congestion of all the ETC gates are equal to or higher than a criterion”.

In a case in which the degree of congestion of the ETC gate is lower than the criterion, the gate selector 123Ab selects the ETC gate (Step S314).

In a case in which the degree of congestion of the ETC gate is equal to or higher than the criterion, the gate selector 123Ab determines whether or not the “time preference” has been selected on the destination setting screen described above (Step S310). In a case in which the “time preference” has been selected, the gate selector 123Ab selects a gate of which the degree of congestion is low (Step S306).

In a case in which the “time preference” has not been selected, the gate selector 123Ab determines whether or not there is the application of a discount at a tollgate through which the subject vehicle will pass (Step S312). In a case in which there is no application of a discount, the gate selector 123Ab selects a gate of which the degree of congestion is low (Step S306). On the other hand, in a case in which there is the application of a discount, the gate selector 123Ab selects an ETC gate (Step S314).

According to the second embodiment described above, in addition to the acquisition of effects similar to those of the first embodiment, a more optimal gate can be selected on the basis of mounting/no-mounting of an ETC card.

The gate selector 123Ab may perform the following process in addition to (or instead of) the process described in the first embodiment or the second embodiment.

### <Modified Example 1>

The gate selector 123Ab may repeatedly select a gate on the basis of information acquired by the information acquirer 123Aa and select a gate such that a gate, which has been selected once, is selected with priority at the second and subsequent selection.

For example, the gate selector 123Ab selects a gate once by acquiring an integral score SCₜₒₜₐₗ using the technique 2 of the first embodiment and thereafter, performs reselection of a gate by repeatedly acquiring an integral score SCₜₒₜₐₗ. At this time, a correction value may be subtracted from the integral score SCₜₒₜₐₗ relating to the gate that has previously been selected.

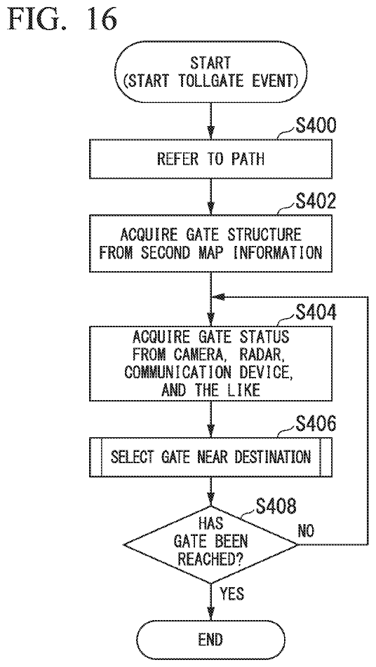

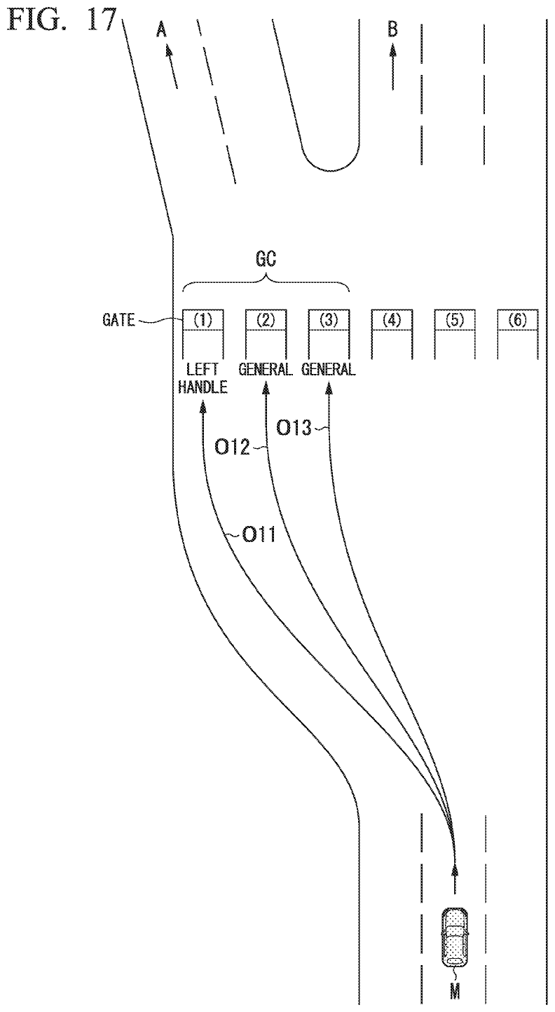

FIG. 16 is a flowchart illustrating an overview of the flow of a process executed by a tollgate passage controller 123A according to Modified example 1. First, the information acquirer 123Aa of the tollgate passage controller 123A acquires a gate structure of a tollgate present in front of the subject vehicle M from the second map information 62 (Step S402) by referring to a path generated by the navigation device 50 (Step S400) and acquires a gate status from the camera 10, the radar device 12, the communication device 20, and the like (Step S404).

Then, the gate selector 123Ab selects a gate near a destination on the basis of information acquired by the information acquirer 123Aa (Step S406).

Next, the gate selector 123Ab determines whether or not the subject vehicle M has reached a gate (Step S408). In a case in which the subject vehicle M has not reached the gate, the processes of Steps S404 and S406 are repeatedly executed. In the middle of the repeated execution, the gate selector 123Ab selects a gate such that a gate that has been selected once is selected with priority.

According to Modified example 1, even in a case in which a situation in front of a tollgate changes, the change can be handled. In addition, by performing control such that a gate, which has been selected once, is selected with priority, occurrence of unnecessary steering several times can be inhibited.

### <Modified Example 2>

The gate selector 123Ab may select a gate on the basis of the position of a left or right side on which a driver seat (a handle or a steering wheel) of the subject vehicle M is present. There are cases in which a left-handle gate is disposed at a tollgate in a country in which right-handle vehicles are dominant. To the contrary, there are cases in which a right-handle gate is disposed at a tollgate in a country in which left-handle vehicles are dominant. In such cases, the gate selector 123Ab selects a left-handle gate with priority when the subject vehicle is a left-handle vehicle in a country in which right-handle vehicles are dominant and selects a right-handle gate with priority when the subject vehicle is a right-handle vehicle in a country in which left-handle vehicles are dominant

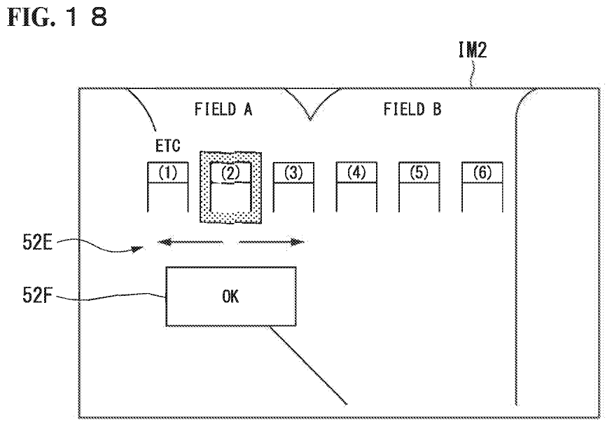

FIG. 17 is an image diagram illustrating a view in which a gate selector 123Ab according to Modified example 2 selects a gate. In the drawing, a gate (1) is a left-handle gate, and gates (2) and (3) are general gates (here, right-handle gates). In this case, the gate selector 123Ab selects the gate (1) in a case in which the subject vehicle M is a left-handle vehicle and selects the gate (2) or (3) in a case in which the subject vehicle M is a right-handle vehicle.

According to Modified example 2, an appropriate gate can be selected in accordance with the position of the driver seat of the subject vehicle M.

### <Modified Example 3>

After selecting a gate, the gate selector 123Ab may display information of the selected gate on a display device of the navigation HMI 52 or the like as a candidate for a passing gate or output the information using a voice using a speaker. In addition, a display screen that is displayed may be an interface screen accepting a gate correcting or determining operation performed by a vehicle occupant.

FIG. 18 is a diagram illustrating one example of a selected gate notification screen IM2. The selection gate notification screen IM2 is an interface screen that is provided by the navigation HMI 52 of the navigation device 50. On this screen, a gate selected by the gate selector 123Ab (a gate (2) in the drawing) is displayed with being emphasized, arrow switches 52E accepting a gate correction, an OK button 52F accepting an operation of determining a passing gate, and the like are set.

According to Modified example 3, a vehicle occupant of the subject vehicle M can acquire a gate to be passed in advance. In addition, by accepting a change of the gate from a vehicle occupant, the subject vehicle can run in a target trajectory that is suitable to the tastes of the vehicle occupant.

### <Modified Example 4>

Before a tollgate event is started, the action plan generator 123 may predict the direction of a destination in front of the tollgate and perform lane change in advance to a lane from which the subject vehicle can easily advance to a gate near the destination.

As above, although a form of the present invention has been described using an embodiment, the present invention is not limited to such an embodiment at all, and various modifications and substitutions can be applied within a range not departing from the concept of the present invention.

What is claim is:

1. A passing gate determining device comprising:
an information acquirer configured to acquire at least information of a lane in which the vehicle is travelling and information of other vehicles directed toward the tollgate in which a plurality of gates are disposed in parallel with each other; and
a gate selector configured to select a gate near a destination set in advance with priority at the tollgate on the basis of the information acquired by the information acquirer,
wherein the gate selector selects a gate positioned on a second gate side in a case in which a degree of congestion in front of the tollgate, which is acquired using the information acquired by the information acquirer, is high and selects a gate positioned on a first gate side in a case in which the degree of congestion in front of the tollgate is low, the first gate having a highest degree of appropriateness to the destination set in advance, the second gate being positioned on an extention of the lane in which the vehicle is travelling.

2. The passing gate determining device according to claim 1, wherein the information acquirer acquires at least one piece of information of a structure of the tollgate, a state of each gate of the tollgate, and a lane in which the vehicle is travelling, and
wherein the gate selector selects a gate on the basis of the information acquired by the information acquirer.

3. (canceled)

4. (canceled)

5. The passing gate determining device according to claim 1,
wherein the information acquirer acquires a position of the vehicle, and
wherein the gate selector selects a gate positioned on a straight line joining a beginning-end portion of a branching road directed toward the destination set in advance and a current position of the vehicle.

6. The passing gate determining device according to claim 1,
wherein the information acquirer acquires a position of a nearby vehicle in the vicinity of the vehicle, and
wherein the gate selector selects a gate on the basis of the position of the nearby vehicle acquired by the information acquirer.

7. The passing gate determining device according to claim 1,
further comprising a mounting state detector configured to detect whether or not a medium used for an automatic toll collecting system is mounted in a medium mounting unit,
wherein the gate selector selects a gate on the basis of a detection result acquired by the mounting state detector.

8. The passing gate determining device according to claim 7,
wherein the information acquirer acquires positions of other vehicles in the vicinity of the vehicle, and
wherein the gate selector, in a case in which it is determined by the mounting state detector that the medium is mounted in the medium mounting unit, selects a gate corresponding to the automatic toll collecting system with priority, and in a case in which it is recognized that there are many vehicles directed toward the gate corresponding to the automatic toll collecting system on the basis of the positions of the other vehicles acquired by the information acquirer, selects a gate at which the number of other vehicles is small regardless whether or not the gate is the gate corresponding to the automatic toll collecting system.

9. The passing gate determining device according to claim 7,
wherein the gate selector, when a user sets the destination, determines whether a gate corresponding to the automatic toll collecting system is selected or a gate not corresponding to the automatic toll collecting system is selected on the basis of a preferred item set together.

10. The passing gate determining device according to claim 7,
wherein the gate selector selects a gate corresponding to the automatic toll collecting system with priority in a case in which it is detected by the mounting state detector that the medium is mounted in the medium mounting unit and sets a gate not corresponding to the automatic toll collecting system as a selection target even in a case in which it is detected by the mounting state detector that the medium is mounted in the medium mounting unit in a case in which there is no application of a discount according to use of the automatic toll collecting system.

11. The passing gate determining device according to claim 1,
wherein the gate selector repeatedly selects a gate on the basis of the information acquired by the information acquirer and selects a gate such that a gate that has been selected is selected with priority in second and subsequent selections.

12. The passing gate determining device according to claim 1,
wherein the gate selector selects a gate on the basis of a position of a left side or a right side on which a driver seat is present in the vehicle.

13. The passing gate determining device according to claim 1, further comprising an output unit configured to output information,
wherein the gate selector outputs information of the selected gate to the output unit as a candidate for a gate to pass.

14. A vehicle control system comprising:
a passing gate determining device according to claim 1; and
an automated driving controller configured to execute automated driving such that the vehicle passes through the gate selected by the passing gate determining device.

15. The vehicle control system according to claim 14,
wherein the automated driving controller executes automated driving such that the vehicle runs in a lane near the gate selected by the gate selector of the passing gate determining device when it comes within a predetermined distance from the tollgate.

16. A passing gate determining method using a computer, the passing gate determining method comprising:
acquiring at least information of a lane in which the vehicle is travelling and information of other vehicles directed toward the tollgate in which a plurality of gates are disposed in parallel with each other; and
selecting a gate near a destination set in advance with priority at the tollgate on the basis of the acquired information,
wherein selecting the gate comprises selecting a gate positioned on a second gate side in a case in which a degree of congestion in front of the tollgate, which is acquired using the information acquired by the information acquirer, is high and selects a gate positioned on a first gate side in a case in which the degree of congestion in front of the tollgate is low, the first gate having a highest degree of appropriateness to the destination set in advance and the second gate being positioned on an extention of the lane in which the vehicle is travelling.

17. A computer-readable non-transitory storage medium storing a program causing a computer to execute:
acquiring at least information of a lane in which the vehicle is travelling and information of other vehicles directed toward the tollgate in which a plurality of gates are disposed in parallel with each other; and
selecting a gate near a destination set in advance with priority at the tollgate on the basis of the acquired information,
wherein selecting the gate comprises selecting a gate positioned on a second gate side in a case in which a degree of congestion in front of the tollgate, which is acquired using the information acquired by the information acquirer, is high and selects a gate positioned on a first gate side in a case in which the degree of congestion in front of the tollgate is low, the first gate having a highest degree of appropriateness to the destination set in advance and the second gate being positioned on an extention of the lane in which the vehicle is travelling.
